(19) United States
(12) Patent Application Publication
(10) Pub. No.: US 2015/0116881 A1
(43) Pub. Date: Apr. 30, 2015

(54) HIGH VOLTAGE DC CIRCUIT BREAKER APPARATUS

(71) Applicants: Alistair Burnett, Stafford (GB); Colin Donald Murray Oates, Brocton (GB); Colin Charnock Davidson, Stafford (GB)

(72) Inventors: Alistair Burnett, Stafford (GB); Colin Donald Murray Oates, Brocton (GB); Colin Charnock Davidson, Stafford (GB)

(73) Assignee: ALSTOM TECHNOLOGY LTD, BADEN (CH)

(21) Appl. No.: 14/379,746

(22) PCT Filed: Mar. 1, 2012
(86) PCT No.: PCT/EP2012/053574

§ 371 Date: Aug. 28, 2014

(51) Int. Cl. H02H 9/02

(52) U.S. Cl. CPC H02H 9/02
USPC 361/93.1

(57) ABSTRACT

A circuit breaker apparatus for use in high voltage direct current (HVDC) power transmission is provided. The circuit breaker apparatus has one module or a plurality of series-connected modules, the or each module including: first, second, third and fourth conduction paths and first and second terminals for connection to an electrical network, each conduction path extending between the first and second terminals, the first conduction path including a mechanical switching element, the second conduction path including at least one semiconductor switching element, the third conduction path including a snubber circuit having an energy storage device and the fourth conduction path including a resistive element.

This invention relates to a circuit breaker apparatus for use in high voltage direct current (HVDC) power transmission.

In power transmission networks alternating current (AC) power is typically converted to direct current (DC) power for transmission via overhead lines and/or undersea cables. This conversion removes the need to compensate for the AC capacitive load effects imposed by the transmission line or cable, and thereby reduces the cost per kilometer of the lines and/or cables. Conversion from AC to DC thus becomes cost-effective when power needs to be transmitted over a long distance.

The conversion of AC to DC power is also utilized in power transmission networks where it is necessary to interconnect AC networks operating at different frequencies. In any such power transmission network, converters are required at each interface between AC and DC power to effect the required conversion.

HVDC converters are vulnerable to DC side faults or other abnormal operating conditions that can present a short circuit with low impedance across the DC power transmission lines or cables. Such faults can occur due to damage or breakdown of insulation, lightning strikes, movement of conductors or other accidental bridging between conductors by a foreign object.

The presence of low impedance across the DC power transmission lines or cables can be detrimental to a HVDC converter. Sometimes the inherent design of the converter means that it cannot limit current under such conditions, resulting in the development of a high fault current exceeding the current rating of the HVDC converter. Such a high fault current not only damages components of the HVDC converter, but also results in the HVDC converter being offline for a period of time. This results in increased cost of repair and maintenance of damaged electrical apparatus hardware, and inconvenience to end users relying on the working of the electrical apparatus. It is therefore important to be able to interrupt the high fault current as soon as it is detected.

A conventional means of protecting a HVDC converter from DC side faults, whereby the converter control cannot limit the fault current by any other means, is to trip an AC side circuit breaker, thus removing the supply of current that feeds the fault through the HVDC converter to the DC side. This is because there are currently no available HVDC circuit breaker designs. Furthermore, almost all HVDC schemes are currently point-to-point schemes with two HVDC converters connected to the DC side, whereby one HVDC converter acts as a power source with power rectification capability and the other HVDC converter acts as a power load with power inversion capability. Hence, tripping the AC side circuit breaker is acceptable because the presence of a fault in the point-to-point scheme requires interruption of power flow to allow the fault to be cleared.

A new class of mesh-connected HVDC power transmission networks are now being considered for moving large quantities of power over long distances, as required by geographically dispersed renewable forms of generation, and to augment existing capabilities of AC transmission networks with smartgrid intelligence and features that are able to support modern electricity trading requirements.

A mesh-connected HVDC power transmission network requires multi-terminal interconnection of HVDC converters, whereby power can be exchanged on the DC side using three or more HVDC converters operating in parallel. Each HVDC converter acts as either a source or sink to maintain the overall input-to-output power balance of the network whilst exchanging the power as required. Faults in the network need to be quickly isolated and segregated from the rest of the network, before an undesirable loss of power throughout the entire network occurs. In addition, fault currents from several converters that act as sources might merge to form a combined fault current, which, if not managed properly, would cause widespread damage to electrical equipment throughout the network.

Current interruption in conventional circuit breakers is carried out when the current reaches a current zero, so as to considerably reduce the difficulty of the interruption task. Thus, in conventional circuit breakers, there is a risk of damage to the current interruption apparatus if a current zero does not occur within a defined time period for interrupting the current. It is therefore inherently difficult to carry out DC current interruption because, unlike AC current in which current zeros naturally occur, DC current cannot naturally reach a current zero.

It is possible to carry out DC current interruption using a conventional AC circuit breaker by applying a forced current zero or artificially creating a current zero. One method of DC current interruption involves connecting an auxiliary circuit in parallel across the conventional AC circuit breaker, the auxiliary circuit comprising a capacitor or a combination of a capacitor and an inductor and being arranged to create an oscillatory current superimposed on the DC load current such that a current zero is created. Such an arrangement typically has a response time of tens of milliseconds, which does not meet the demands of HVDC grids that require a response time in the range of a few milliseconds.

EP 0 867 998 B1 discloses a conventional, solid-state DC circuit breaker comprising a stack of series-connected IGBTs in parallel with a metal-oxide surge arrester. This solution achieves the aforementioned response time but suffers from high steady-state power losses.

According to an aspect of the invention, there is provided a circuit breaker apparatus for use in high voltage direct current (HVDC) power transmission, the circuit breaker apparatus comprising one module or a plurality of series-connected modules;

the or each module including: first, second, third and fourth conduction paths; and first and second terminals for connection to an electrical network, each conduction path extending between the first and second terminals;

the first conduction path including a mechanical switching element to selectively allow current to flow between the first and second terminals through the first conduction path in a first mode of operation or commutate current from the first conduction path to the second conduction path in a second mode of operation;

the second conduction path including at least one semiconductor switching element to selectively allow current to flow between the first and second terminals through the second conduction path or commutate current from the second conduction path to the third conduction path in the second mode of operation, wherein an arc voltage of the mechanical switching element exceeds an on-state voltage across the semiconductor switching element or the plurality of semiconductor switching elements;

the third conduction path including a snubber circuit having an energy storage device to control a rate of change of voltage across the mechanical switching element and oppose current flowing between the first and second terminals in the second mode of operation;

the fourth conduction path including a resistive element to absorb and dissipate energy in the second mode of operation and divert charging current from the first and second terminals away from the energy storage device to limit a maximum voltage across the first and second terminals.

In use, the circuit breaker apparatus may be connected in series with a DC network, and may be further connected in series with a conventional AC circuit breaker or disconnector. Connecting the circuit breaker apparatus to the DC network causes current to flow through the first conduction path of the or each module during normal power transmission in the DC network. Use of the mechanical switching element, e.g. a vacuum interrupter, in the first conduction path reduces conduction losses during normal operation of the DC network when compared to an equivalently rated semiconductor-based switch.

In the event of a fault occurring in the DC network resulting in high fault current, the or each semiconductor switching element is turned on and the mechanical switching element is opened to commutate the current from the first conduction path to the second conduction path. This results in formation of an arc between contact elements of the mechanical switching element. The presence of an arc voltage across the contact elements of the mechanical switching element causes commutation of the current from the first conduction path to the second conduction path. This in turn causes the arc to be extinguished and thereby minimises wear of the contact elements, which extends the lifetime of the mechanical switching element.

The difference between the arc voltage of the mechanical switching element and the on-state voltage across the semiconductor switching element or the plurality of the semiconductor switching elements affects the speed of commutation of current from the first conduction path to the second conduction path.

A mechanical switching element with fast current chop and high arc voltage characteristics is ideal for use with a parallel-connected semiconductor switching element or a parallel-connected set of semiconductor switching elements to commutate the mechanical switching element from a conducting state to a blocking state. This is because the arc between the contact elements within the mechanical switching element commutates quickly without dissipating much energy. In contrast, the use of a semiconductor-based switch in the first conduction path that is able to carry the load current with the required low on-state voltage drop would have a large stored charge in the semiconductor junction when the semiconductor-based switch is in the conduction state. The stored charge would then have to be dissipated to recover the device into a blocking state when current is commutated from the first conduction path to the second conduction path. This requires a larger rating of the or each semiconductor switching element in the second conduction path and other components of the circuit breaker apparatus, in order to cope with the additional dissipation duty and therefore makes the equipment less economical in terms of size, weight and costs.

The mechanical switching element provides a very low conduction voltage drop at low cost and complexity, and is thereby suitable to carry the current from the DC network at all times when breaking or current limiting functions are not required. This not only provides a cost-efficient configuration that significantly decreases the power loss of the circuit breaker apparatus, but also reduces plant cooling requirements and operating costs of the circuit breaker apparatus, thus resulting in an economical equipment design.

The mechanical switching element must be rated to match the available rating of the or each semiconductor switching element in the module. The sub-division of the overall DC network voltage rating into individual voltage ratings for a plurality of series-connected modules, which may number in the hundreds, allows the use of freely available medium-voltage mechanical switching elements and semiconductors. Furthermore, the mechanical switching element requires only a short travel distance of its contact elements, which allows fast operation that is required for reliable current interruption but with a low actuation force. This therefore results in a practical and cost-efficient circuit breaker apparatus.

After the arc between the contact elements of the mechanical switching element is extinguished, the or each semiconductor switching element is turned off to commutate the current from the second conduction path to the third conduction path. Opening the mechanical switching element alters its voltage withstand capability, which increases with separation in gap between the contact elements until the final contact separation distance is reached. Flow of current in the third conduction path charges the energy storage device, e.g. a capacitor, of the snubber circuit, which restricts the rate of rise of voltage applied across the mechanical switching element to a lower value than the rate of rise of withstand capability of the mechanical switching element. This allows the voltage applied across the mechanical switching element to be kept at a lower value than the voltage withstand capability of the mechanical switching element as the contacts are moving.

In the absence of the snubber circuit from the or each module, the mechanical switching element would require its contact elements to be fully separated before the or each semiconductor switching element may be turned off to commutate the current from the second conduction path to the third conduction path. This would detrimentally decrease the speed of operation of the circuit breaker apparatus. Turning off the or each semiconductor switching element, before the contact elements of the mechanical switching element have fully parted, could prevent a successful interruption of current and damage the mechanical switching element.

The snubber circuit also removes any voltage surges occurring from circuit inductance when the or each semiconductor switching element in the or each module is turned off which could otherwise damage the or each semiconductor switching element.

The inclusion of the snubber circuit in the or each module therefore improves the speed of operation and reliability of the circuit breaker apparatus.

Charging the energy storage device also results in the formation of an opposing voltage to the voltage on the DC network that forms across the module or the plurality of series-connected modules when coordinated together, and is capable of driving the DC network current to a defined value. At the same time, the resistive element of the fourth conduction path fixes the voltage applied across each module to within safe levels, even when current from the DC network is still present between the first and second terminals, by diverting the current away from the snubber circuit and through the resistive element. The circuit breaker apparatus must therefore be designed to contain enough modules connected in series to have a sufficient collective voltage margin to not only absorb and dissipate the voltage surge produced by inductive energy stored in the DC network, but also cope with the nominal voltage rating of the DC network in order to drive the current to zero.

If the current is driven to zero, the apparatus behaves as a circuit breaker. A second conventional AC circuit breaker or disconnector connected in series with the apparatus may then be switched to an open state to complete the circuit breaking process by providing isolation for safety purposes. Otherwise, if the opposing voltage drives the current to a non-zero value, then the apparatus behaves as a current limiter. In this case, the conventional AC circuit breaker may either remain closed or may be omitted in the first place.

After the fault in the DC network has been cleared, the circuit breaker apparatus may revert to its normal operating mode by closing the mechanical switching element. The resistive element discharges the energy storage device to its steady-state voltage level to allow the mechanical switching element to be safely reclosed. Otherwise, if the energy storage device is still charged to a level substantially above its steady-state voltage level, the ability of the apparatus to perform a subsequent current breaking procedure may be impaired. This is because a high rate of rise of voltage would be applied across the mechanical switching element during the subsequent current breaking procedure, since the voltage across the mechanical switching element increases approximately step-wise to the voltage across the energy storage device.

The configuration of the or each module in the circuit breaker apparatus therefore results in the or each module forming a self-contained unit that can selectively apply a voltage drop into the DC network. The use of a plurality of series-connected modules allows the circuit breaker apparatus to either break or limit current in a DC network. The number of modules provided can be varied to suit low-, medium- and high-voltage electrical applications but is usually rated such that use of all modules drives the current to zero in a given application.

In order to limit current in the DC network, the circuit breaker apparatus may be operated such that only some of the modules provide an opposing voltage to drive the current to a non-zero value, while the remaining modules are left in a bypass mode and thereby do not provide an opposing voltage.

The current-limiting operation may be achieved through use of an embodiment of the circuit breaker apparatus, in which the circuit breaker apparatus includes a plurality of series-connected modules, wherein, in use, the or each semiconductor switching element of one or more modules may switch to commutate current from the second conduction path to the third conduction path in the second mode of operation whilst the or each semiconductor switching element of the or each other module may switch to allow current to flow between the first and second terminals through the second conduction path. The modular arrangement of the circuit breaker apparatus permits duty-cycling of the modules collectively in sequenced patterns of second, third and fourth conduction paths during the current limiting mode to make full use of the available rating of the apparatus. This also allows the opposing voltage to be adjusted to drive the current to any non-zero value that is less than the original fault current level.

Preferably the or each semiconductor switching element selectively allows current to flow between the first and second terminals through the second conduction path in the first mode of operation.

The circuit breaker apparatus may be required to revert to its normal operating mode within a predetermined period of time after breaking or limiting current. As described earlier, if the energy storage device is still charged above its steady-state voltage level during re-closing of the mechanical switching element, the ability of the apparatus to perform a subsequent current breaking procedure may be impaired. The or each semiconductor switching element may be operated to momentarily allow current to flow between the first and second terminals through the second conduction path. If the fault has not yet been cleared, the or each semiconductor switching element is turned off to stop the flow of current through the circuit breaker apparatus very quickly.

In the event that the fault has been cleared but the energy storage device is still charged above its steady-state voltage level, the or each semiconductor switching element may be momentarily switched to allow the second conduction path to conduct current during normal operation of the DC network until the voltage across the energy storage device has decayed to its steady-state voltage level. During this period, although power losses are higher than normal, such power losses are still acceptable because of the brief period of exposure to the higher losses. At this time, the mechanical switching element is closed to allow current to flow between the first and second terminals through the first conduction path before the or each semiconductor switching element is turned off to resume normal operation.

In embodiments of the invention, the mechanical switching element may include retractably engaged contact elements located within a dielectric medium. Such a mechanical switching element may, for example, be a vacuum interrupter.

The choice of dielectric medium affects the voltage withstand capability of the mechanical switching element. The dielectric medium may be a high-performance dielectric medium, which may be, but not limited to oil, vacuum or sulphur hexafluoride. Use of high-performance dielectric media enables a small separation between the contact elements of the mechanical switching element to result in a high isolation voltage. This in turn facilitates rapid switching of the mechanical switching element, since the contact elements are only required to travel a short distance to achieve the required separation. A short separation between the contact elements also reduces the actuation energy required to operate the mechanical switching element, thus reducing the size, cost and weight of the circuit breaker apparatus.

In still further embodiments, the or each semiconductor switching element may be or may include an insulated gate bipolar transistor, a gate turn-off thyristor, a gate-commutated thyristor, an integrated gate-commutated thyristor or a MOS-controlled thyristor. The or each semiconductor switching element may be connected in parallel with an anti-parallel diode.

The or each semiconductor switching element may be made from, but not limited to, silicon or a wide-band-gap semiconductor material such as silicon carbide, diamond or gallium nitride.

The required current rating of the or each semiconductor switching element may vary depending on whether the or each module is used to break or limit the current This is because the or each semiconductor switching element is only required to be momentarily switched into circuit once during the circuit breaking event with a duration in the order of milliseconds. However, when the corresponding module is used to limit current, the or each semiconductor switching element is then required to be continuously switched into circuit, or required to switch the corresponding module in and out of bypass on a duty cycle for tens or hundreds of milliseconds, thus requiring a higher and continuous power rating of the or each semiconductor switching element.

The resistive element may include at least one linear resistor and/or at least one non-linear resistor, e.g. a metal-oxide varistor.

Preferably the fourth conduction path further includes an auxiliary switching element connected to the resistive element, the auxiliary switching element being operable to modify flow of current through or voltage drop across the resistive element. The auxiliary switching element may be, for example, a solid-state switch such as a thyristor or an IGBT, or a mechanical switch such as a vacuum interrupter or a high-voltage relay.

The use of the auxiliary switching element allows the resistive element to be selectively switched into or out of circuit to modify the flow of current through or voltage drop across the resistive element so as to control the absorption and dissipation of energy by the resistive element. When the resistive element consists of a plurality of resistive element parts, the auxiliary switching element and the plurality of resistive element parts may be arranged so that the auxiliary switching element is able to switch some of the resistive element parts, instead of the entire resistive element, out of circuit when modifying the flow of current through or the voltage drop across the resistive element, whilst the other resistive element parts remain in circuit.

The configuration of the or each module may vary depending on the requirements of the circuit breaker apparatus.

In embodiments of the invention, the first, second and third conduction paths may be connected in parallel between the first and second terminals.

In other embodiments of the invention, the energy storage device and the resistive element may be connected in parallel, and the snubber circuit may further include a diode connected to the parallel combination of the energy storage device and resistive element.

The use of the diode in the snubber circuit removes the need to fully discharge the energy storage device to zero volts before the or each semiconductor switching element is turned on and/or the mechanical switching element is closed. Otherwise omission of the diode from the snubber circuit might result in a large current being drawn from the capacitor, which may damage the or each semiconductor switching element and/or the mechanical switching element.

In addition, the use of the diode in the snubber circuit allows the energy storage device to be maintained at a minimum voltage level and thereby enables its use as an energy source for a local power supply used within the or each module to power equipment such as the IGBT and an actuator of the mechanical switching element.

On the other hand, the snubber circuit may omit the diode to reduce the size, weight and cost of the circuit breaker apparatus.

In embodiments of the circuit breaker apparatus employing the use of a plurality of series-connected modules, one or more modules may be connected in reverse direction to one or more other modules, so as to control and/or break current in both directions.

In further embodiments of the invention, the second conduction path may include two semiconductor switching elements; and the snubber circuit may include an energy storage device and two diodes, each semiconductor switching element being connected in series with a respective one of the diodes of the snubber circuit to define a set of current flow control elements, the sets of current flow control elements being connected in parallel with the energy storage device in a full-bridge arrangement.

The use of one or more modules configured in this manner results in a circuit breaker apparatus with bidirectional current breaking and limiting capabilities.

Preferably the fourth conduction path may be connected in parallel with the energy storage device of the snubber circuit, or connected in parallel with the first, second and/or third conduction paths.

The circuit breaker apparatus may further include a power supply to power one or more components of the circuit breaker apparatus. For example, the power supply may be or may include a transformer to receive and rectify a ripple current, an optically driven power supply, a turbine generator coupled with an alternator or DC generator, a fuel cell, a flow battery or a thermoelectric generator.

Preferred embodiments of the invention will now be described, by way of non-limiting examples, with reference to the accompanying drawings in which:

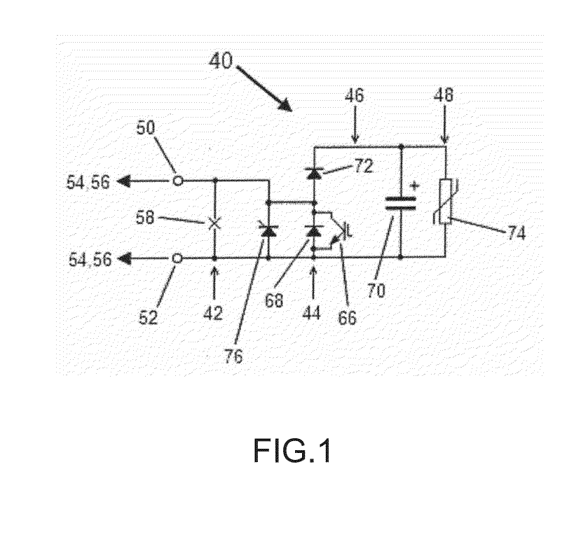

FIG. 1 shows, in schematic form, a module forming part of a circuit breaker apparatus according to a first embodiment of the invention;

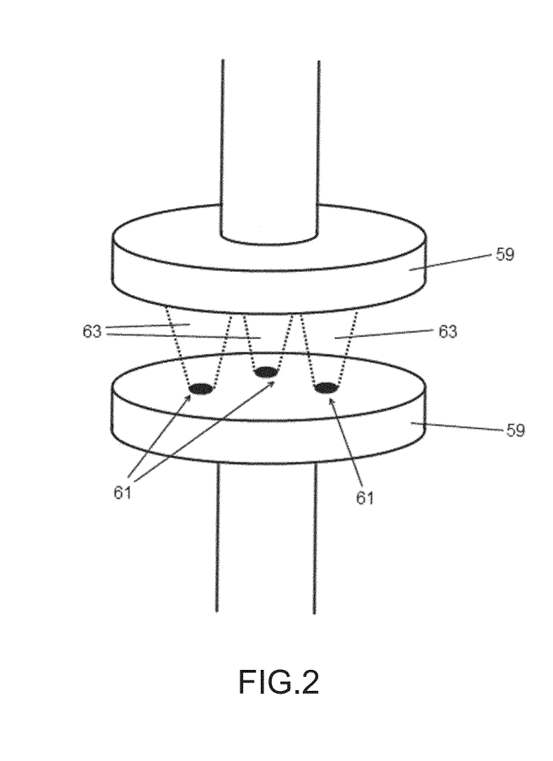

FIG. 2 shows cathode spots formed during arcing between contact elements of a vacuum interrupter;

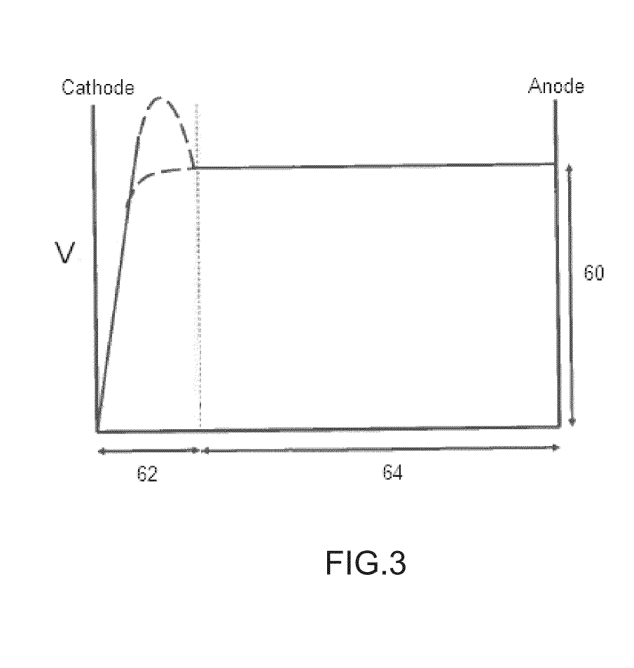

FIG. 3 illustrates variations in voltage across the comparative lengths of a cathode spot and an arc plasma respectively;

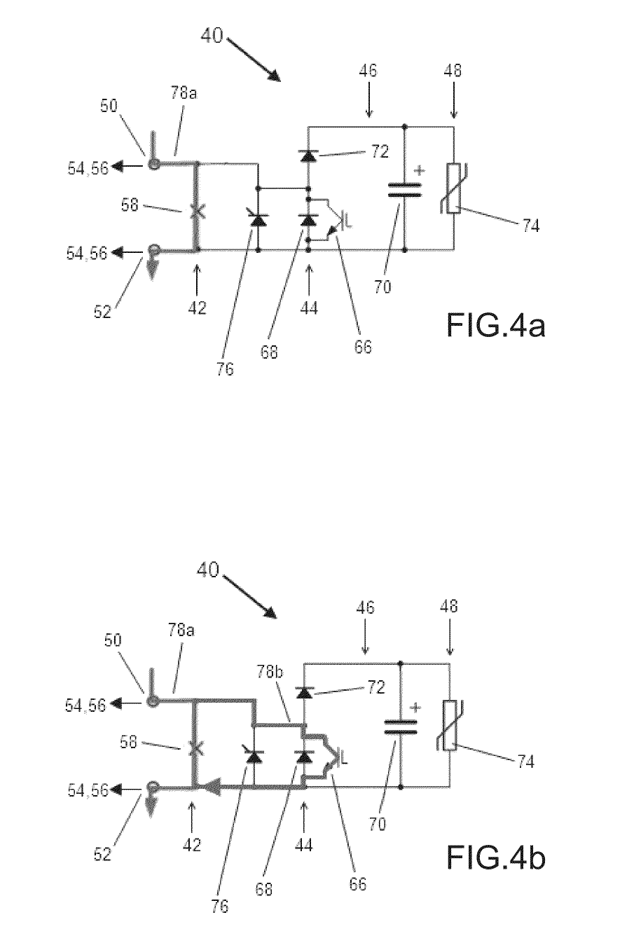

FIGS. 4a to 4f illustrate the operation of the module of FIG. 1 to break or limit current;

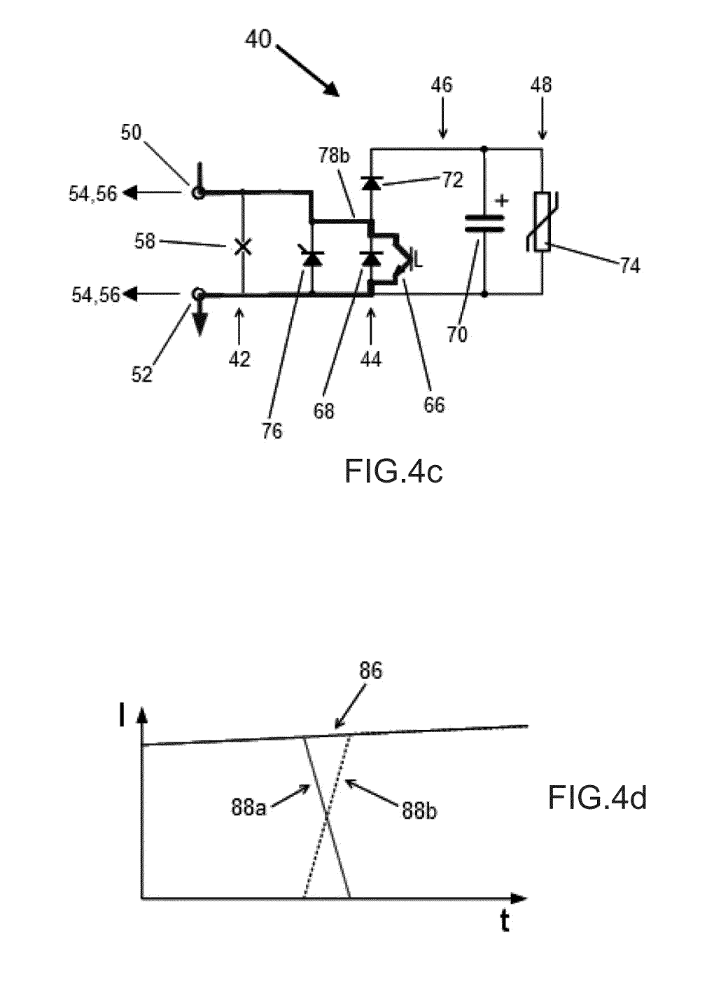

FIG. 5 illustrates the changes in voltage and current in the conduction paths of the module of FIG. 1;

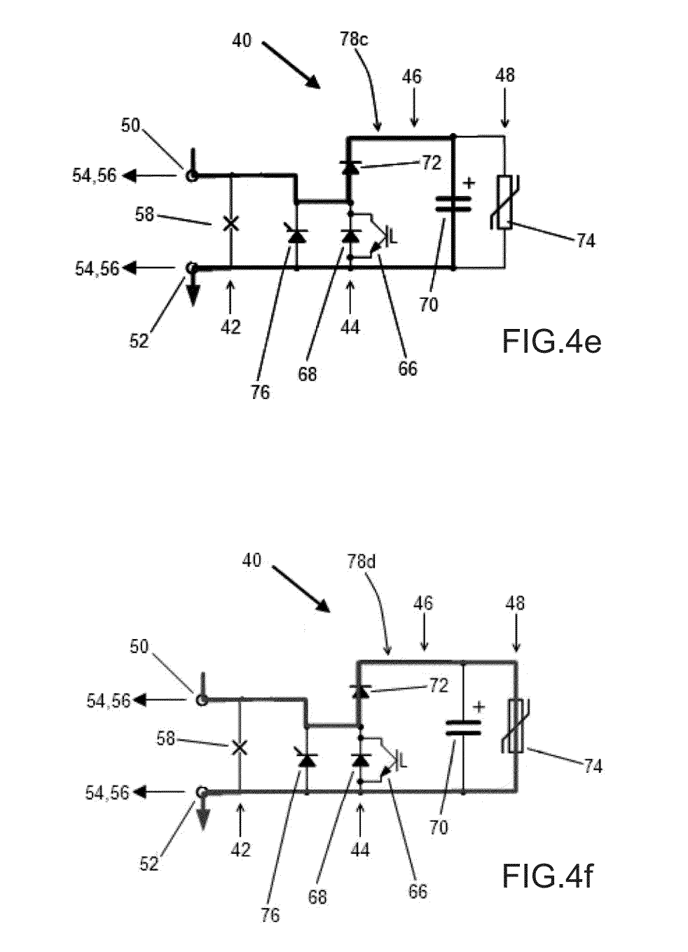

FIG. 6 shows, in schematic form, a module forming part of a circuit breaker apparatus according to a second embodiment of the invention;

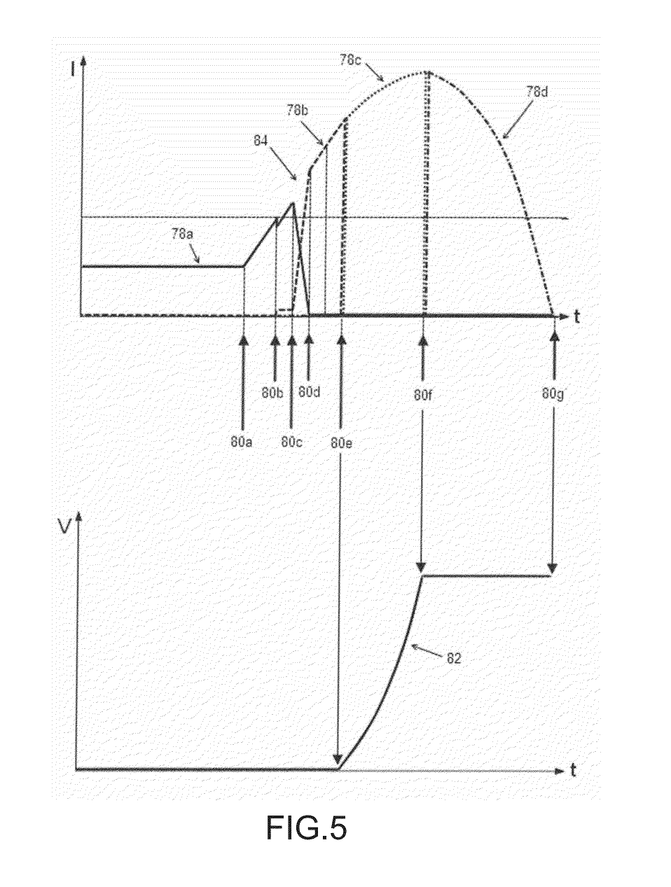

FIG. 7 shows, in schematic form, a module forming part of a circuit breaker apparatus according to a third embodiment of the invention;

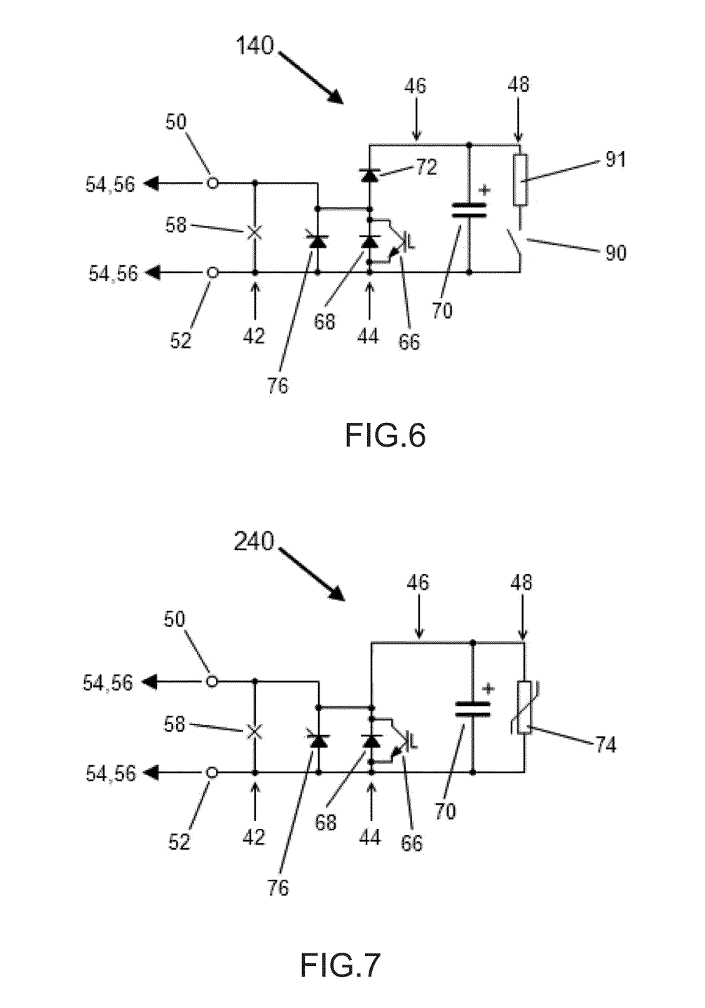

FIG. 8 shows, in schematic form, a module forming part of a circuit breaker apparatus according to a fourth embodiment of the invention;

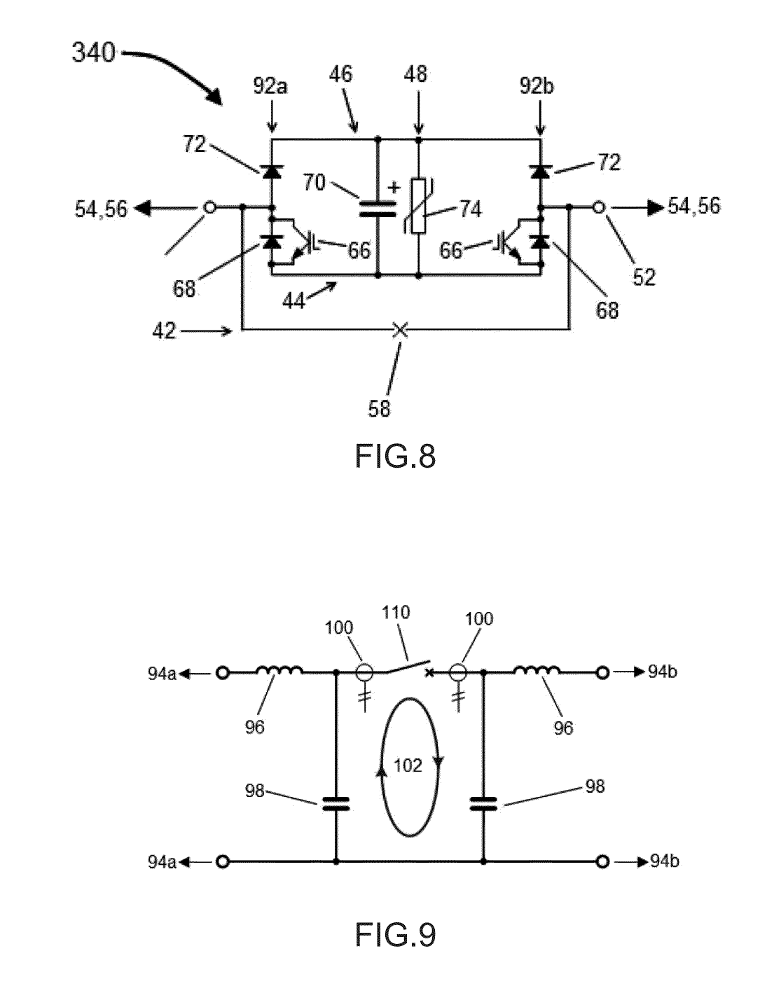

FIG. 9 shows a circuit for supplying power to a circuit breaker apparatus, according to a fifth embodiment of the invention, through injection of a ripple current into the load current of the DC network when the circuit breaker apparatus includes a power supply in the form of a receiving transformer; and

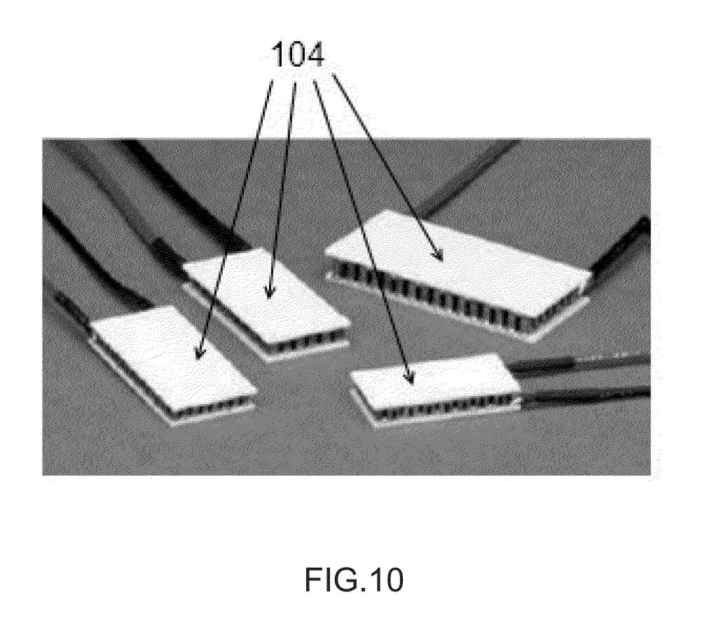

FIG. 10 shows Peltier effect thermoelectric devices that form part of a thermoelectric generator to supply power to a circuit breaker apparatus.

A module 40 forming part of a circuit breaker apparatus according to a first embodiment of the invention is shown in FIG. 1.

The first circuit breaker apparatus comprises a plurality of series-connected modules 40. Each module 40 includes: first, second, third and fourth conduction paths 42,44,46,48; and first and second terminals 50,52.

In use, the first and second terminals 50,52 of each module 40 are connected in series with a DC network 54 and an AC circuit breaker 56.

The first conduction path 42 includes a mechanical switching element in the form of a vacuum interrupter 58 with retractably engaged contact elements 59 located inside a vacuum, as shown in FIG. 2. The vacuum interrupter 58 has a deterministic arc voltage in the range of 20 to 40 V. It will be appreciated that the vacuum interrupter 58 preferably has fast current chop and high arc voltage characteristics.

The arc voltage of a vacuum interrupter 58 is determined by the geometry and material of its contact elements. An arc forms inside a vacuum from metal vapour that has boiled off the surface of a contact element 59. Since the boiling of metal vapour can only be sustained if the localised heating effect is sufficiently high, the current flowing through the vacuum interrupter 58 concentrates into narrow cathode spots 61, as shown in FIG. 2. The high current density at each cathode spot 61 means that nearly all of the arc voltage 60 is developed across the cathode spot length 62 with minimal voltage developing across the length 64 of the arc plasma 63, as shown in FIG. 3.

Fast current chopping in the vacuum interrupter 58 results from rapid cooling of the cathode spots due to heat transfer into the surrounding bulk of the contact material. When the heating effect of the current becomes low enough to eliminate the boiling of metal vapour, the arc will be rapidly extinguished, and will not restart if the contact gap is sufficiently large.

The second conduction path 44 includes a semiconductor switching element in the form of an insulated gate bipolar transistor (IGBT) 66, which is connected in parallel with an anti-parallel diode 68. The IGBT 66 typically has a voltage rating of 3.3 kV or 4.5 kV and an on-state voltage drop of approximately 3.0 V at rated current.

The third conduction path 46 includes a snubber circuit, which includes a capacitor 70 and a diode 72 arranged to define a capacitor-diode turn-off snubber arrangement.

The first, second and third conduction paths 42,44,46 are connected in parallel between the first and second terminals 50,52.

The fourth conduction path 48 has a resistive element in the form of a metal-oxide varistor 74, which is connected in parallel with the capacitor 70 of the snubber circuit. The metal-oxide varistor 74 is a non-linear resistor, which has a high resistance at low voltages and a low resistance at high voltages.

In other embodiments of the invention (not shown), it is envisaged that the metal-oxide varistor may be replaced by a plurality of metal-oxide varistors, at least one other non-linear resistor, at least one linear resistor, or a combination thereof

The first circuit breaker apparatus further includes a thyristor 76 connected in parallel with the IGBT 66. The thyristor 76 may be turned on during transient fault currents in the reverse direction to protect the anti-parallel diode 68 from over current and damage. This allows the first circuit breaker apparatus to be connected, in use, to a DC network having a mesh structure with load and fault currents of different polarities.

In other embodiments, it is envisaged that, if the current is required to be controlled and/or broken in both directions, one or more additional modules may be connected in series with and in reverse direction to the existing plurality of modules to control and/or break current flow in the opposite direction.

It is envisaged that, in other embodiments, the thyristor 76 may be omitted from each module 40. In these embodiments, the diode 68 may be protected from over-current by closing the mechanical switching element 58 to commutate the transient fault current from the second conduction path 44 to the first conduction path 42.

Operation of each module 40 of the first circuit breaker apparatus in FIG. 1 to break current in the DC network 54 is described as follows, with reference to FIGS. 4a to 4f and FIG. 5.

FIG. 5 illustrates the changes in current and voltage in the conduction paths 42,44,46,48 in the module 40 of FIG. 1 during the current breaking procedure.

During normal operating conditions of the DC network 54, the vacuum interrupter 58 is closed to allow current 78a to flow through the DC network 54, the AC circuit breaker 56 and the first conduction path 42 of the module 40, as shown in FIG. 4a. At this stage the current 78a does not flow through the second, third and fourth conduction paths 44,46,48, and there is no significant voltage drop 82 across the vacuum interrupter 58 or the IGBT 66.

A fault or other abnormal operating condition in the DC network 54 may lead to high fault current flowing through the DC network 54.

In response to an event 80a of high fault current in the DC network 54, the IGBT 66 is switched to an on-state 80b, which causes the current 78a to begin commutating from the first conduction path 42 to the second conduction path 44, as shown in FIG. 4b. This causes current 78b to flow in the second conduction path 44. A trip coil of the vacuum interrupter 58 is then activated to initialize separation 80c of the vacuum interrupter's contact elements, which leads to formation of an arc between the separating contact elements. The presence of an arc voltage across the contact elements causes the current 78a to fully commutate 84 from the first conduction path 42 to the second conduction path 44, as shown in FIG. 4c, thus fully extinguishing the arc 80d.

The arc voltage of the vacuum interrupter 58 being higher than the on-state voltage of the IGBT 66 results in rapid commutation 84 of the current 78a from the first conduction path 42 to the second conduction path 44, typically within a period of 1 millisecond.

The rate, di/dt, at which the current 78a commutates from the first conduction path 42 to the second conduction path 44 is calculated as follows:

$$\frac{d i}{d t} = \frac{{V}_{arc} - {V}_{IGBT}}{{L}_{stray}}$$

Where V_{arc} is the arc voltage across the contact elements of the vacuum interrupter 58;

V_{IGBT} is the on-state voltage of the IGBT 66; and

L_{stray} is the stray inductance of the conductor loop formed by the vacuum interrupter 58 and IGBT 66.

For example, if V_{arc} is 33 V, V_{IGBT} is 3 V and L_{stray} is 50 nH, the rate at which the current 78a commutates from the first conduction path 42 to the second conduction path 44 is 600 A per microsecond.

FIG. 4d illustrates the changes in current flowing through the first and second conduction paths 42,44 with time. It is shown that the rate 86 of rise of current in the DC network 54 is much lower than the rate of commutation of current from the first conduction path 42 to the second conduction path 44, which is given by the rates 88a,88b of change of current in the first and second conduction paths 42,44.

The IGBT 66 is then turned off 80e to commutate the current 78b flowing in the second conduction path 44 into the third conduction path 46, as shown in FIG. 4e. This causes current 78c to flow in the third conduction path 46 and into the capacitor 70, which charges at a rate given as follows:

$$\frac{d {V}_{C}}{d t} = \frac{{I}_{C}}{C}$$

Where dV_{C}/dt is the rate of change of voltage across the capacitor 70;

I_{C} is the current 78c flowing through the third conduction path 46; and

C is the capacitance of the capacitor 70.

Charging of the capacitor 70 results in an increase in voltage 82 across the capacitor 70, which is applied across the vacuum interrupter 58 and the IGBT 66, as shown in FIG. 5. In order to protect the vacuum interrupter 58, the voltage 82 applied across the vacuum interrupter 58 is kept lower than the voltage withstand capability of the vacuum interrupter 58, which increases to its rated value with increasing separation in the gap between its contact elements until the final contact separation distance is reached. This is achieved by setting the capacitance value of the capacitor 70 to control the rate of rise of voltage across the capacitor 70 to be lower than the rate of rise of voltage withstand capability of the vacuum interrupter 58. A typical time period for the rise of voltage withstand capability for separating contact elements in the vacuum interrupter 58 to attain a final voltage withstand value is 1 to 2 milliseconds.

The voltage 82 across the capacitor 70 produces a back electromotive force that opposes the fault current flowing through the DC network 54, the AC circuit breaker 56 and the first circuit breaker apparatus. The metal-oxide varistor 74 is activated 80f, if and when the capacitor voltage reaches the safe limit for the vacuum interrupter 58 and IGBT 66 to divert any extra charging current 78d through the fourth conduction path 48, as shown in FIG. 4f. The metal-oxide varistor 74 thus absorbs and dissipates energy from the DC network 54 whilst the back electromotive force is building up to control the DC network current.

The back electromotive force eventually becomes sufficiently large across all the series-connected modules 40 to absorb the inductive energy from the DC network and drive the current to zero within a reasonable amount of time. After the current reaches zero 80g, the series-connected AC circuit breaker 56 is opened to complete the current breaking procedure and isolate the fault in the DC network 54.

If the first circuit breaker apparatus is required to be re-closed shortly after the current breaking procedure has been completed, the AC circuit breaker 56 is closed, followed by the IGBTs 66 in all the series-connected modules 40 being turned on to allow current to flow through the second conduction path 44. However, if the fault is still present in the DC network 54, the IGBTs 66 in all the series-connected modules 40 may be rapidly turned off to halt current flow through the first circuit breaker apparatus. On the other hand, if the fault in the DC network 54 has been cleared, the first circuit breaker apparatus may then revert to its normal operating mode by closing the vacuum interrupters 58 in all the series-connected modules 40 before turning off all the IGBTs 66 to resume normal operation of the DC network 54.

In circumstances where the fault has been cleared but the capacitor 70 is still charged to a level substantially above its steady-state voltage level, the AC circuit breaker 56 is closed, followed by the IGBTs 66 being turned on in all the series-connected modules 40 to allow current to flow through the second conduction path 44. Meanwhile the metal-oxide varistor 74 discharges the capacitor 70 to its steady-state voltage level in all the modules 40. This minimises the risk of the voltage of the capacitor 70 impairing the ability of the vacuum interrupters 58 in the series-connected modules 40 to undergo a subsequent current breaking procedure. After the capacitors 70 have reverted to their steady-state voltage level, the vacuum interrupters 58 in all of the modules 40 are closed before the IGBTs 66 are turned off to resume normal operation of the DC network 54.

To operate the first circuit breaker apparatus in a current-limiting mode, some of the series-connected modules 40 are operated so that their capacitors 70 produce a back electromotive force to oppose part of the current flowing through the DC network 54 and thereby drive the current to a lower non-zero value or prevent a further rise of current. Meanwhile the remaining modules 40 are operated so that their IGBTs 66 remain turned on to allow current to continue flowing between the first and second terminals 50,52 through the corresponding second conduction paths 44, and so their capacitors 70 do not contribute any back electromotive force to drive the current to the lower non-zero value.

The modular arrangement of the first circuit breaker apparatus permits duty-cycling of the modules to make full use of the available rating of the first circuit breaker apparatus. This also allows the generated back electromotive force to be smoothly varied from zero voltage to the required voltage.

Optionally the first circuit breaker apparatus may be initially operated in the current-limiting mode before switching to the current-breaking mode. This may be useful in circumstances where the first circuit breaker apparatus is required to temporarily take over current-breaking duties from another circuit breaker, which has failed to perform a current-breaking procedure.

The first circuit breaker apparatus is therefore capable of breaking and/or limiting current in the DC network 54.

The parallel connection of the vacuum interrupter 58 and the IGBT 66 in the first circuit breaker apparatus is advantageous in that it minimises conduction losses during normal operation of the DC network 54 and enables rapid commutation of the current from the first conduction path 42 to the second conduction path 44 in the event of high fault current in the DC network 54. The latter not only improves the response time of the first circuit breaker apparatus, but also minimises wear of the contact elements and thus increases the lifetime of the vacuum interrupter 58.

A module 140 forming part of a circuit breaker apparatus according to a second embodiment of the invention is shown in FIG. 6. The second circuit breaker apparatus includes a plurality of series-connected modules 140. Each module 140 of the second embodiment of the circuit breaker apparatus in FIG. 6 is similar in terms of structure and operation to each module 40 of the first embodiment of the circuit breaker apparatus in FIG. 1, and like features share the same reference numerals.

Each module 140 of the second circuit breaker apparatus differs from each module 40 of the first circuit breaker apparatus in that, in each module 140 of the second circuit breaker apparatus, the fourth conduction path 48 further includes an auxiliary switching element 90 connected in series with a linear resistor 91.

The auxiliary switching element 90 may be, for example, a solid-state switch such as a thyristor or an IGBT, or a mechanical switch such as a vacuum interrupter or a high-voltage relay.

It is envisaged that, in other embodiments of the invention, the linear resistor 91 may be replaced by a plurality of linear resistors, at least one other linear resistor, at least one non-linear resistor, e.g. a metal-oxide varistor, or a combination thereof. It is further envisaged that, in embodiments employing the use of a plurality of resistors, the auxiliary switching element 90 may be configured to selectively switch either some or all of the plurality of resistors into and out of circuit.

The provision of the auxiliary switching element 90 in each module 140 of the second circuit breaker apparatus allows the linear resistor 91 to be selectively switched into or out of circuit to control the absorption and dissipation of energy by the linear resistor 91.

A module 240 forming part of a circuit breaker apparatus according to a third embodiment of the invention is shown in FIG. 7. The third circuit breaker apparatus includes a plurality of series-connected modules 240. Each module 240 of the third embodiment of the circuit breaker apparatus in FIG. 7 is similar in terms of structure and operation to each module 40 of the first embodiment of the circuit breaker apparatus 40 in FIG. 1, and like features share the same reference numerals.

Each module 240 of the third circuit breaker apparatus differs from each module 40 of the first circuit breaker apparatus in that, in each module 240 of the third circuit breaker apparatus, the third conduction path 46 omits the diode of the snubber circuit. This has the benefit of reducing the size, weight and cost of the third circuit breaker apparatus 240.

Omission of the diode from the snubber circuit however means that the capacitor 70 must be fully discharged to zero volts before the IGBT 66 is turned on and/or the vacuum interrupter 58 is closed. Otherwise a large current drawn from the capacitor 70 may damage the IGBT 66 and/or the vacuum interrupter 58. This in turn means that the capacitor 70 cannot be relied upon as a power supply energy source for the vacuum interrupter 58, IGBT 66 or thyristor 76 in each module 240 when the third circuit breaker apparatus 240 is open.

A module 340 forming part of a circuit breaker apparatus according to a fourth embodiment of the invention is shown in FIG. 8. The fourth circuit breaker apparatus includes a plurality of series-connected modules 340. Each module 340 of the fourth embodiment of the circuit breaker apparatus in FIG. 8 is similar in terms of structure and operation to each module 40 of the first embodiment of the circuit breaker apparatus in FIG. 1, and like features share the same reference numerals.

Each module 340 of the fourth circuit breaker apparatus differs from each module 40 of the first circuit breaker apparatus in that, in each module 340 of the fourth circuit breaker apparatus:
the second conduction path 44 includes two IGBTs 66, which are connected back to back;
the snubber circuit includes a capacitor 70 and two diodes 72, each IGBT 66 being connected in series with a respective one of the diodes of the snubber circuit to define a set of current flow control elements 92a,92b, the sets of current flow control elements 92a,92b being connected in parallel with the capacitor 70 in a full-bridge arrangement.

The configuration of the module in this manner results in a circuit breaker apparatus 340 with bi-directional current-breaking and/or current-limiting capabilities.

A circuit breaker apparatus 110 according to a fifth embodiment of the invention is shown in FIG. 9. The fifth circuit breaker apparatus 110 includes a plurality of series-connected modules (not shown). Each module of the fifth circuit breaker apparatus 110 is similar in terms of structure and operation to each module 40 of the first embodiment of the circuit breaker apparatus 40 in FIG. 1.

Each module of the fifth circuit breaker apparatus 110 differs from each module 40 of the first circuit breaker apparatus 40 in that, in the fifth circuit breaker apparatus 110, the module further includes a power supply to drive the trip coil of the vacuum interrupter, IGBT, thyristor and to optionally power local control and monitoring plant associated with the fifth circuit breaker apparatus 110. The power supply is in the form of a receiving transformer (not shown), through which the load current flows.

FIG. 9 shows, in schematic form, a circuit interconnecting two DC networks 94a,94b. The circuit includes a pair of auxiliary inductors 96, each of which is connected in series with a pole of a respective DC network 94a,94b, and a pair of auxiliary capacitors 98, each of which defines a branch connected in parallel with each DC network 94a,94b. The fifth circuit breaker apparatus 110 is connected between the auxiliary inductors 96, at the first or second terminal of each series-connected module at each end of the fifth circuit breaker apparatus and is connected between the parallel-connected branches to define a “π” configuration of the fifth circuit breaker apparatus 110 and the parallel-connected branches.

The circuit further includes a pair of driving transformers 100, each of which is located on a respective end of the fifth circuit breaker apparatus 110 between the parallel-connected branches.

In other embodiments of the invention, it is envisaged that each driving transformer may instead be connected in series with a respective one of the auxiliary capacitors 98, so that each branch includes a series connection of an auxiliary capacitor and a driving transformer. In such embodiments, both driving transformers may be positioned on the ground side potential of the circuit so as to obviate the need to install high voltage insulation on the driving transformers and thereby decrease their manufacturing cost.

In use, the vacuum interrupter is closed, and the driving transformers 100 are controlled to inject a ripple current into the load current flowing through the closed, fifth circuit breaker apparatus 110. Each module (not shown) receives the ripple current using a receiving transformer connected in series with the first and second terminals. The ripple current is then rectified to produce a local power source for the module components such as the IGBT and mechanical switching element.

The pairs of auxiliary inductors 96 and auxiliary capacitors 98 define two line traps that provide a current loop return path 102. The inclusion of the line traps in the circuit prevents the injected ripple current from entering other sections of the DC networks 94a,94b. The line traps shown in FIG. 9 use first order filter networks but may have higher order filtering with multiple inductive, capacitive and resistive elements in place of the pairs of auxiliary inductors 96 and auxiliary capacitors 98 shown in FIG. 9.

When the current through the fifth circuit breaker apparatus 110 is driven to zero, the driving current transformers 100 are not then able to inject the ripple current into the fifth circuit breaker apparatus 110 in order to provide the local power source. Thus, there may not be any power to close the vacuum interrupter once the power supply has discharged its stored energy. It may therefore be required to generate power to close the vacuum interrupter through other methods.

One method may be to harvest power from the capacitor of the snubber circuit to generate power to close the vacuum interrupter. However, during the operation of the fifth circuit breaker apparatus 110, the capacitor may be discharged to zero volts, and not undergo subsequent charging whilst the vacuum interrupter is closed.

Another method may be to pneumatically close the vacuum interrupter to complete the circuit and thereby allow power to be supplied to the modules using the driving transformers 100. This eliminates the requirement to generate power to close the vacuum interrupter, thus resulting in savings in terms of overall cost, size and weight of the equipment.

It will be appreciated that the above two methods may be used in combination to effect closing of the vacuum interrupter.

It is envisaged that, in other embodiments of the invention, the power supply may be:
an optically driven power supply, which may include an electrically insulated optical fibre and laser diode to supply optical energy to the module, which further includes photovoltaic receivers to convert the optical energy and thereby generate electrical power;
a turbine generator located within the module which may be powered by de-ionised water, compressed air, or any other suitable medium which is supplied through electrically insulated piping from ground level. The flow of de-ionised water or compressed air may be connected in series through the modules to conserve the amount of piping used. The module might further include an alternator or DC generator, which is powered by the turbine generator and therefore in turn supplies electrical power to the module;
a fuel cell or flow battery located within the module. Fuel or electrolyte is pumped through insulated piping from ground level to the fuel cell or flow battery. An electrochemical reaction generates electric power for use by the module from the fuel or electrolyte using the fuel cell or flow battery; or
a thermoelectric generator located within the module, which includes one or more Peltier effect thermoelectric devices, as shown in FIG. 10. A Peltier effect thermoelectric device includes a thermocouple, which may be, but is not limited to, a bismuth telluride rich semiconducting structure, sandwiched between two ceramic tile heat transfer surfaces. One heat transfer surface may be kept at near ambient temperature using, but not limited to, an air-cooled heat sink whilst the other heat transfer surface may be heated using a hot water loop with electrically insulated and lagged piping from ground level. Other means of creating the same temperature difference may also be employed. Flow of water may be arranged in a series or parallel configuration between modules. This results in a temperature difference of tens of degrees Celsius between the two ceramic tile heat transfer surfaces of the Peltier effect thermoelectric device, which causes heat transfer through the thermocouple material and thereby generation of electrical ionic charge. This is converted to a usable supply voltage by a DC to DC switchmode converter which powers the module.

Use of electrical actuation to open and close the vacuum interrupter typically has a power requirement in the range of tens of watts. The power requirement of the power supply may be reduced to a few watts through use of hydraulic or pneumatic actuation to charge a latched spring of the vacuum interrupter mechanism to a closed position. The medium for hydraulic or pneumatic actuation may be, but is not limited to, compressed air or de-ionised water and may be supplied using electrically insulated piping. Once the spring is charged in the closed position, it may be released to open the vacuum interrupter through use of electrical actuation means such as a solenoid coil.

It is further envisaged that, in other embodiments of the invention, the circuit breaker apparatus may include a combination of any of the features described with reference to the above embodiments.

1. A circuit breaker apparatus for use in high voltage direct current (HVDC) power transmission, the circuit breaker apparatus comprising one module or a plurality of series-connected modules, the or each module including first, second, third and fourth conduction paths; and first and second terminals for connection to an electrical network, each conduction path extending between the first and second terminals, the first conduction path including a mechanical switching element to selectively allow current to flow between the first and second terminals through the first conduction path in a first mode of operation or commutate current from the first conduction path to the second conduction path in a second mode of operation, the second conduction path including at least one semiconductor switching element to selectively allow current to flow between the first and second terminals through the second conduction path or commutate current from the second conduction path to the third conduction path in the second mode of operation, wherein an arc voltage of the mechanical switching element exceeds an on-state voltage across the semiconductor switching element or the plurality of semiconductor switching elements, the third conduction path including a snubber circuit having an energy storage device to control a rate of change of voltage across the mechanical switching element and oppose current flowing between the first and second terminals in the second mode of operation, the fourth conduction path including a resistive element to absorb and dissipate energy in the second mode of operation and divert charging current from the first and second terminals away from the energy storage device to limit a maximum voltage across the first and second terminals, the circuit breaker apparatus including further a plurality of series-connected modules, wherein, in use, the or each semiconductor switching element of one or more modules switches to commutate current from the second conduction path to the third conduction path in the second mode of operation whilst the or each semiconductor switching element of the or each other module switches to allow current to flow between the first and second terminals through the second conduction path.

2. (canceled)

3. A circuit breaker apparatus according to claim 1, wherein the or each semiconductor switching element selectively allows current to flow between the first and second terminals through the second conduction path in the first mode of operation.

4. A circuit breaker apparatus according to claim 1, wherein the mechanical switching element includes retractably engaged contact elements located within a dielectric medium.

5. A circuit breaker apparatus according to claim 1, wherein the or each semiconductor switching element is or includes an insulated gate bipolar transistor, a gate turn-off thyristor, a gate-commutated thyristor, an integrated gate-commutated thyristor or a MOS-controlled thyristor.

6. A circuit breaker apparatus according to claim 1, wherein the resistive element includes at least one linear resistor and/or at least one non-linear resistor.

7. A circuit breaker apparatus according to claim 1, wherein the fourth conduction path further includes an auxiliary switching element connected to the resistive element, the auxiliary switching element being operable to modify flow of current through or voltage drop across the resistive element.

8. A circuit breaker apparatus according to claim 1, wherein the first, second and third conduction paths are connected in parallel between the first and second terminals.

9. A circuit breaker apparatus according to claim 1, wherein the energy storage device and the resistive element is connected in parallel, and the snubber circuit further includes a diode connected to the energy storage device.

10. A circuit breaker apparatus according to claim 1 and further including a plurality of series-connected modules, wherein one or more modules is connected in reverse direction to one or more other modules.

11. A circuit breaker apparatus according to claim 1, wherein
the second conduction path includes two semiconductor switching elements; and
the snubber circuit includes an energy storage device and two diodes, each semiconductor switching element being connected in series with a respective one of the diodes of the snubber circuit to define a set of current flow control elements, the sets of current flow control elements being connected in parallel with the energy storage device in a full-bridge arrangement.

12. A circuit breaker apparatus according to claim 1, wherein the fourth conduction path is connected in parallel with the energy storage device of the snubber circuit.

13. A circuit breaker apparatus according to claim 1, wherein the fourth conduction path is connected in parallel with the first, second and/or third conduction paths.

14. A circuit breaker apparatus according to claim 1, further including a power supply to power one or more components of the circuit breaker apparatus, wherein the power supply is or includes a transformer to receive and rectify a ripple current, an optically driven power supply, a turbine generator coupled with an alternator or DC generator, a fuel cell, a flow battery or a thermoelectric generator.
